(19) United States
(12) Patent Application Publication
(10) Pub. No.: US 2011/0275465 A1
(43) Pub. Date: Nov. 10, 2011

(54) Tensioning Device

(75) Inventors: Russel Vincent Gillis, Schomberg (CA); Edilbert Delgado Yu, Ajax (CA)

(73) Assignee: Eurospec Manufacturing Inc., Newmarket (CA)

(21) Appl. No.: 13/101,780

(22) Filed: May 5, 2011

Related U.S. Application Data
(60) Provisional application No. 61/331,495, filed on May 5, 2010.

(51) Int. Cl. F16H 7/12

(52) U.S. Cl. 474/133

(57) ABSTRACT

A tensioning device is provided to aid in the maintenance and replacement of a drive member of a drive system. The tensioning device operates to maintain tension in the drive member during prolonged use of the drive system through a biased roller that receives and guides the drive member and adapts continuously to maintain tension as the drive member changes properties through use. The tensioning device further operates to ease the replacement of the drive member by being rotatable against the bias to provide slack within the drive member, such that the drive member may be removed from the belt drive system. The tensioning device includes an arm and a base, with the arm being capable of limited rotation about the base. The arm includes the roller for guiding the drive member and is biased in one direction to maintain tension within the drive member. The arm may be rotated against the bias towards an engaged position wherein the arm is restricted from counter rotation in the direction of the bias. While in (or substantially in) the engaged position, slack is introduced within the drive member such that the drive member may be removed. When a new or refurbished drive member has been replaced to the drive system, a further rotation of the arm disengages the arm from its restriction and is biased back towards a position of tension wherein the roller re-engages with the drive member to ensure tension in the belt drive system.

### CROSS REFERENCE TO RELATED APPLICATIONS

This application claims priority from U.S. Provisional Application No. 61/331,495 filed on May 5, 2010; the contents of which are incorporated herein by reference.

### FIELD OF THE INVENTION

The present invention relates to tensioning devices for flexible drive members.

### BACKGROUND

It is usual to transmit power between a pair of rotating devices through an endless flexible drive member, either a drive belt or a chain drive. Common applications of such drives are the accessories associated with the engine of a vehicle or the drive from a motor to machine components operating in synchronism in a stationary machine.

In order to provide a stable, reliable drive, it is necessary to ensure that slippage between the drive and driven components does not occur. This is done by ensuring that the flexible drive member remains engaged with the drive and driven components and that changes in the length of the flexible member are accommodated.

The usual manner of providing for engagement is by providing a tensioning device that engages the belt or chain to remove any slack from the drive train. The tensioning device includes an arm that is biased into engagement with the flexible drive member by a spring. This accommodates minor variations in the length of the drive member but also ensures the proper engagement between the drive and driven components. The flexible drive member may pass around a number of components to avoid multiple drive members being employed and therefore the force applied by the tensioning device may be significant.

The flexible drive member must be changed at specified periods and inspected at regular service intervals to ensure that a catastrophic loss of drive is not encountered. In order to change the flexible drive member, the tension applied by the tensioning member must be removed, which means that the bias forcing the tensioning arm into engagement with the drive belt must be overcome. This requires the application of significant torque to overcome the spring and then some manner of holding the arm against the bias of the spring whilst the drive member is inspected and/or replaced.

Various tools exist to assist in this operation. Typically, these include a lever that can be engaged with the arm of the tensioning device and used to rotate it out of the operational position. The arm is then held whilst the belt is removed. This of course requires considerable dexterity on the part of the mechanic. Other tools exist that provide for a mechanical stop to be inserted to hold the arm in the released position but again it is often difficult to insert the stop whilst maintaining the force on the lever.

It is therefore an object of the present invention to obviate or mitigate the above disadvantages.

### BRIEF DESCRIPTION OF THE DRAWINGS

An embodiment of the invention will now be described by way example only with reference to the accompanying drawings in which:

FIG. 1 is a representation of a serpentine belt drive as implemented on an automotive application including an exemplary tensioning device;

FIG. 2 is an exploded view showing the components of an exemplary tensioning device shown in FIG. 1;

FIG. 3 is a plan of view of the exemplary tensioning device shown in FIG. 2 in an assembled condition;

FIG. 4 is a section on the line IV-IV of FIG. 3;

FIG. 5 is a section on the line V-V of FIG. 3;

FIG. 6 is a view similar to FIG. 4 showing the exemplary tensioning device in an disengaged position;

FIG. 7 is a view similar to FIG. 6 showing the exemplary tensioning device in a engaged position; and

FIG. 8 is a perspective view of the latching mechanism used in the embodiment of FIG. 4.

### SUMMARY OF THE INVENTION

In general terms, there is provided a tensioning device for use in a drive system, comprising a base, a follower rotatably mounted on the base, a control mechanism acting between the base and the follower to control the rotation of the follower about the base, the control mechanism comprising a biasing element to bias the follower towards an engaged position and a holding element to hold the follower in a disengaged position against the bias.

In one embodiment the present invention provides a tensioning device to bias a follower into engagement with a flexible drive member. The follower is rotably mounted on a base and a latch mechanism is provided between the follower and the base. The latch mechanism is configured to act between the base and the follower when the follower is moved to a predetermined position to hold the follower in that position against the bias applied to the follower. The latch is released by relative movement between a follower and a base and allows the follower to be biased into engagement with the drive member.

### DETAILED DESCRIPTION OF THE INVENTION

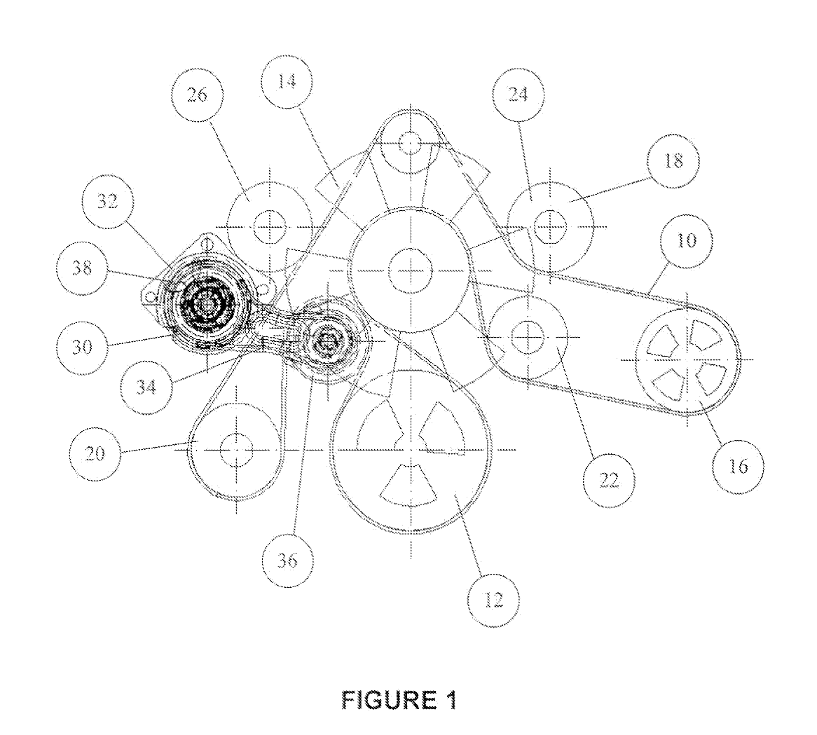

Referring to FIG. 1, a flexible drive member 10 in the form of a ribbed V-belt is utilized on an automobile engine to transmit rotation from a crank shaft pulley 12 to different accessories. In this embodiment, the accessories include a cooling fan 14, an alternator assembly 16, power steering pump 18, and exhaust gas recirculation pump 20. Idler pullies indicated at 22, 24 and 26 are provided to maintain the desired path of the belt 10. It will be appreciated that the components in the path are merely exemplary, as is the particular application, and that serpentine drives using a flexible drive member, such as a belt or chain, may be utilized in a variety of applications including automotive, power transmission and machinery drives for a variety of industries.

To maintain a desired tension in the belt 10, a tensioning device 30 is incorporated in the serpentine path. The tensioning device 30 includes a base 32 and a follower comprising an arm 34 that carries a roller 36. A control mechanism, described in greater detail below, acts between the base 32 and the arm 34. The control mechanism includes a biasing element, such as a torsion spring, to move the arm 34 in a counter clockwise direction, as viewed in FIG. 1, to apply a tension to the belt 10, in an engaged position. In order to remove the belt 10, the arm 34 may be moved in a clockwise direction towards a disengaged position to release the tension and allow the belt to be removed from the various components.

As can be seen in the Figures, embodiments of the present technology include a base and a follower (or arm) whose relative disposition is determined by a control mechanism that includes a biasing element and a holding element. In normal operation, the base and follower are rotatably biased in one direction relative to one another by a biasing element. For maintenance, the base, the follower, or both, are rotated against the bias towards an disengaged state. The disengaged state is maintained by a holding element which restricts counter-rotation from the biasing element. Normal operation may be resumed by releasing the holding element such that the biasing element is allowed to rotate the base, the follower, or both, in the direction of the bias towards an engaged position wherein the drive member is engaged by the tensioning device.

The control mechanism's elements may be integral to one another, may form part of either or both of the base and the follower, or may be separate components. The exemplary control mechanism shown in the Figures includes a torsion spring and a latch mechanism. Other suitable control mechanisms exist which achieve substantially the same hold and release functionality and are considered to be alternative embodiments of the present technology.

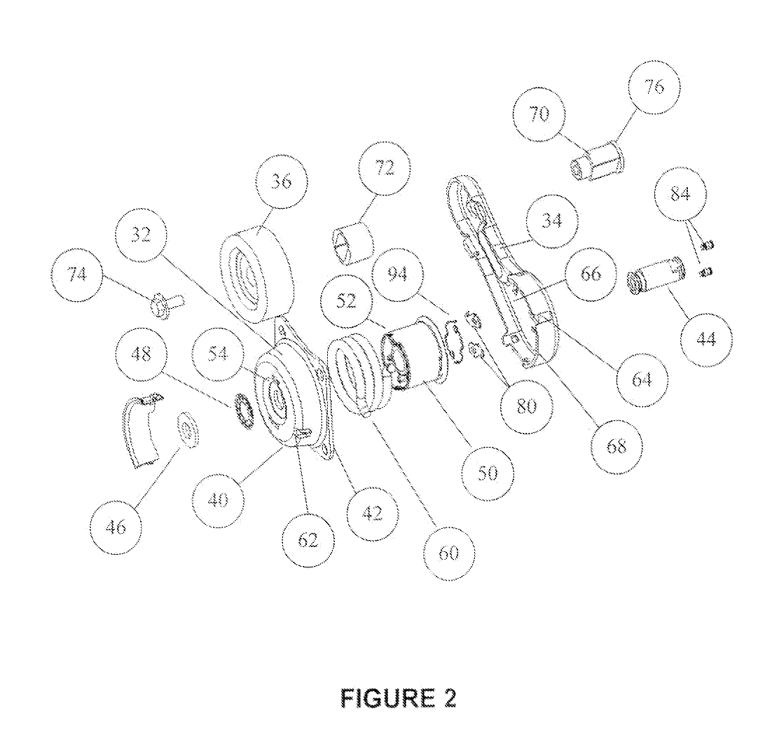

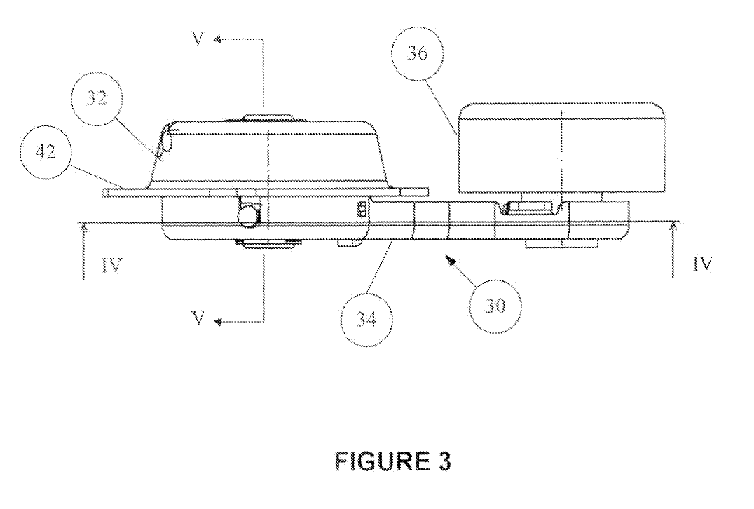

As can be seen in greater detail in FIGS. 2 and 3, the base 32 includes a cup 40 integrally formed with a mounting flange 42. An inner shaft 44 is secured to the cup 40 through a nut 46 and washer 48.

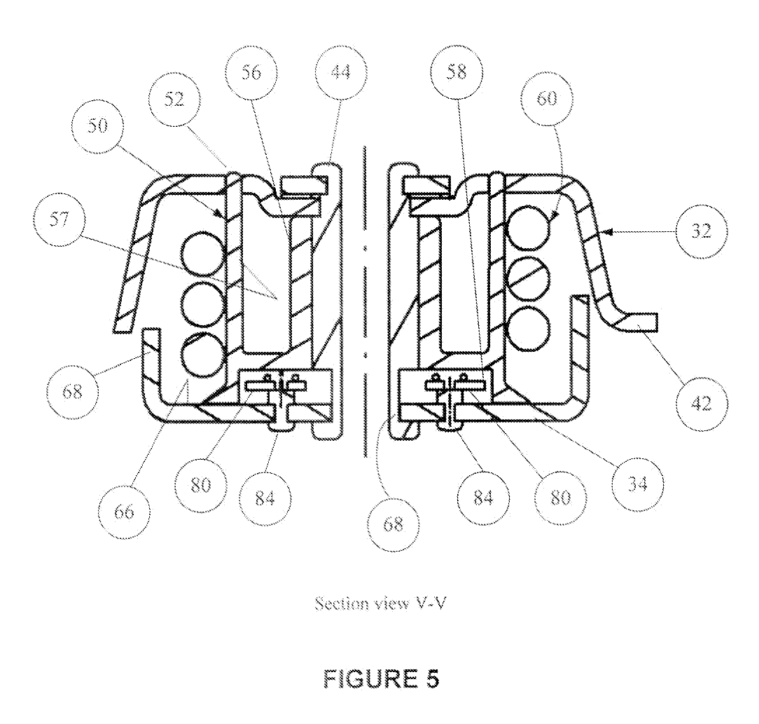

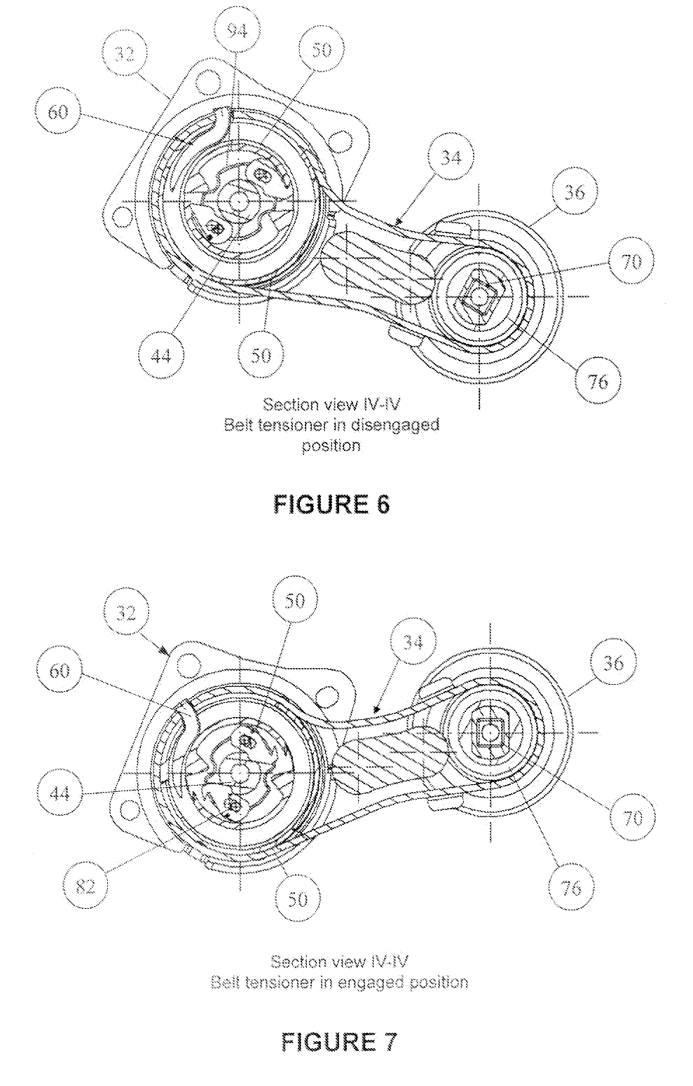

A hub 50 is mounted to the cup 40 through tangs 52 formed on its end face that pass through slots 54 formed in the base 40. The hub 50 has an inner wall 56 (FIG. 5), that is a snug fit on the shaft 44 and radially locates the hub 50, and an outer wall 57. The end of the hub 50 opposite to the flanges 52 is formed with a recessed shoulder 58 that extends between the inner wall 56 and the radially outer wall 57 of the hub 50. The outer wall 57 extends axially beyond the shoulder 58 to locate the arm 34.

A torsion spring 60 is supported on the hub 50 to encompass the outer wall 57, with one end of the torsion spring 60 passing through a hole 62 in the cup 40. The opposite end of the spring 60 engages a slot 64 formed in the periphery of the arm 34. The arm 34 has a planar body 66 and a flange 68 extending inwardly from the body 66 to cover the outer portions of the spring 60. The planar body 66 has a central aperture that is located on the inner shaft 44. The shaft 44 therefore defines the axis of rotation of the arm 34 relative to the base 32 and the end face of the hub 50 axially locates the arm 34 relative to the base 32.

The distal portion of the arm 34 carries the roller 36 that is mounted on the stub shaft 70. The stub shaft 70 is carried through a square hole in the planar face 66 of the arm 34 and has a spacer 72 mounted between the stub shaft and the roller 36. A bolt 74 secures the roller to the stub shaft with the spacer 72 maintaining it at the required distance from the planar face 66. The stub shaft 70 has a socket 76 formed in its outer end to allow a lever to engage the socket and rotate the arm 34 relative to the base 32 for servicing.

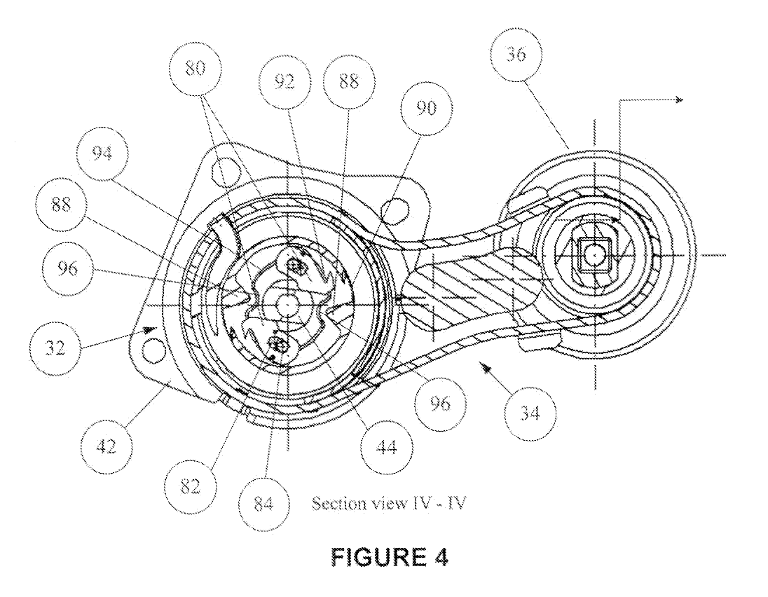

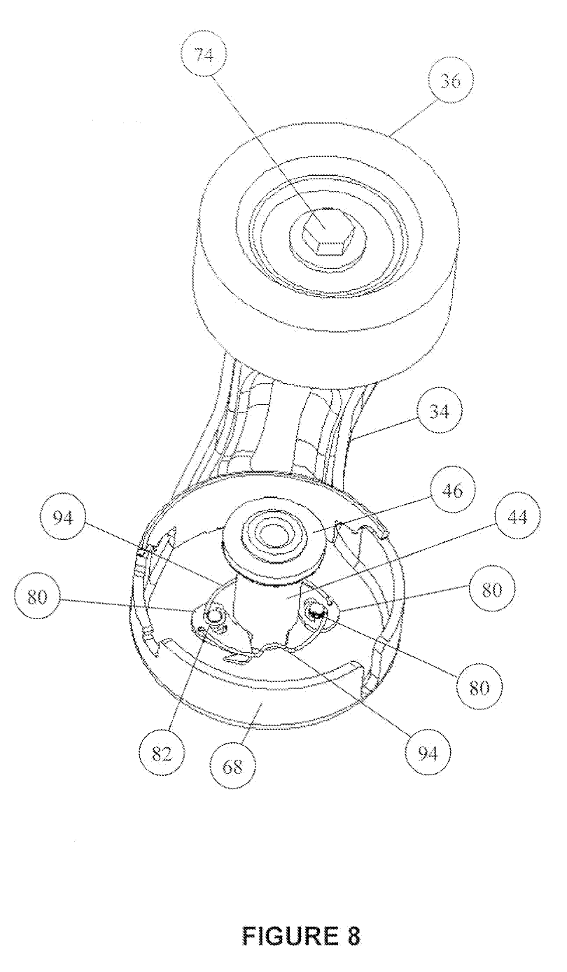

The planar body 66 carries a pair of pawls 80 that are pivotally mounted on rivets 84 carried on the planar body 66. The pawls are located in the recess between the shoulder 58 and the planar face 66. As can best be seen in FIG. 4 and FIG. 8, the pawls 80 are connected to the rivet 84 through a slot 82 that provides a lost motion to allow limited circumferential movement of the pawl 80 relative to the hub 50. The outer wall 57 of the hub 50 is formed with a pair of diametrically opposed cams 88 that project radially inwardly toward the main shaft 44. The outer wall 57 is slotted adjacent to each of the cams 88 as indicated at 90 to provide a re-entrant barb that is configured to engage a hook 92 of the pawl 80. A pair of over center hair springs 94 extend around the shaft 44 and engage with the pawls 80 at one end. The opposite end is located on the rivets 84 and a part circular depression 96 is formed in the springs 94 at a location adjacent to the cams 88. The connection of the springs 94 to the pawls 80, relative to the rivets 84, is configured so as to move between two stable positions to either rotate the pawl radially outwardly into an engaging position or maintain them in a radially inwardly retracted position depending upon the relative disposition of the arm 34 and the base 32.

In the position shown in FIG. 4, the pawls 80 are retracted and the hooks 92 are located radially inwardly of the outer wall 57. In this position the arm 34 is free to rotate under the bias of the spring 60 in a counter clockwise direction as shown in FIG. 1 and apply tension to the belt 10. The torque applied by the torsion spring 60 to the arm 34 applies a substantially constant tension to the belt 10 and accommodates changes in the length of the belt as the service conditions change.

When the belt 10 is to be removed for service, a wrench is located in the socket 76 and a torque applied to the arm 34 to move it clockwise against the bias of the spring 60. Rotation of the arm 34 carries the pawls 80 and the springs 94 in a clockwise direction relative to the hub 50. As the arm 34 attains a predetermined position relative to the base 32, that is not normally encountered in operation, the springs 94 engage the cams 88 causing the springs to go over center. The springs 94 cause the pawls 80 to be rotated about the rivets 84 radially outwardly so that the hooks 92 enter the slots 90. Slight release of the clockwise torque causes the hooks 92 to engage the re-entrant surface of the slot 90 to inhibit further counter clockwise movement between the arm 34 and the base 32 under the bias of the spring 60. This provides a stable secure latch for the arm 34 and allows the belt to be removed for service.

Upon completion of the service, the latched arm 34 may be released by moving the arm 34 clockwise relative to the base 32. The clockwise movement again causes the springs 94 to engage the cams 88 and induce a retraction of the pawls 80 from the slots 90. With the pawls 80 retracted, the arm may be moved counter clockwise allowing the roller 36 to engage the belt 10 and apply the tension. The pawls attain the condition shown in FIG. 4 allowing free movement of the arm 34 under the bias of the spring 60.

It will be noted that the provision of the pawls and the cooperation with the central hub provides a selectively operable latch that maintains the arm 34 in a stable retracted position relative to the base 32, thereby facilitating removal of the belt 10.

It will be apparent that other forms of selectively operable latch may be incorporated into the device to provide latching as the arm is retracted and release of the latch for subsequent operation.

The hub and follower may be formed using any conventional technique including stamping.

What is claimed is:

1. A tensioning device for use with a drive member, comprising:
a base;
a follower rotatably mounted on the base;
a control mechanism acting between the base and the follower to control the rotation of the follower about the base, the control mechanism comprising a biasing element to bias the follower towards an engaged position and a holding element to hold the follower in a disengaged position against the bias.

2. The tensioning device of clam 1 wherein said control mechanism causes said holding element to hold the follower in said disengaged position upon attainment of said predetermined disposition of said follower relative to said base.

3. The tensioning device of claim 1 wherein the control mechanism further comprises a releasing element for releasing the follower from disengaged position.

4. The tensioning device of claim 3 wherein said control operates said releasing element upon relative movement between said follower and said base from said disengaged position in a direction away from said engaged position.

5. The tensioning device of claim 1 wherein the biasing element is a torsion spring.

6. The tensioning device of claim 1 wherein said holding element and said release element are incorporated in a latch mechanism.

7. The tensioning device according to claim 6 wherein said control mechanism includes an actuator to initiate engagement and disengagement of said latch mechanism.

8. The tensioning device of claim 7 wherein said latch mechanism includes a pawl moveable by said actuator between an operable position in which said follower is rotatable relative to said base and an operable position in which said pawl inhibits relative rotation between said follower and said base.

9. The tensioning device of claim 8 wherein said actuator is mounted on one of said base and follower for movement therewith, and said pawl is mounted on the other of said base and follower for movement therewith, relative rotation of said base and follower effecting relative movement between said actuator and pawl.

10. The tensioning device of claim 9 where said pawl is pivotally mounted on the other of said base and follower.

11. The tensioning device according to claim 9 wherein said actuator is connected to said pawl through a bistable spring to move said pawl between said inoperable position and operable position.

12. The tensioning device according to claim 11 wherein said actuator includes a cam operable upon said spring to move said spring from one stable position to another.

13. The tensioning device according to claim 12 wherein said cam operates on said spring to move said spring from said other stable position to said one stable position to release said follower from said disengaged position.

14. The tensioning device of claim 1 wherein the follower comprises an arm.

15. The tensioning device of claim 14 further comprising:
a mounted portion of the arm;
a distal portion of the arm, the distal portion being apart from the mounted portion;
a shaft member connected to the distal portion; and
a roller mounted on the shaft member such that the roller is spaced apart from the arm.

16. A method of operating a tensioning device for use with a drive member, the tensioning device having a base, a follower rotatably mounted on the base and a control mechanism, the method comprising:
controlling the rotation of the follower about the base;
biasing the follower towards an engaged position;
holding the follower in a disengaged position against the bias; and
releasing the follower from disengaged position.
